(19) United States
(12) Patent Application Publication
(10) Pub. No.: US 2004/0075570 A1
(43) Pub. Date: Apr. 22, 2004

(54) Remote detection of railroad wheel and bearing temperature apparatus and method

(75) Inventor: Mark Bartonek, Blue Springs, MO (US)

Correspondence Address: SENNIGER POWERS LEAVITT AND ROEDEL, ONE METROPOLITAN SQUARE, 16TH FLOOR, ST LOUIS, MO, 63102, US

(73) Assignee: General Electric Company

(21) Appl. No.: 10/274,217

(22) Filed: Oct. 18, 2002

(51) Int. Cl. G08B 21/00

(52) U.S. Cl. 340/682; 340/584

(57) ABSTRACT

An apparatus for detecting a temperature of a railroad train wheel or bearing comprises a lens positioned in close proximity to a railroad track such that infrared radiation radiating from the wheel or bearing of a train traversing the track is collected by the lens and directed toward a focal point of the lens. The collected radiation is indicative of the temperature of the wheel or bearing. A fiber optic cable has a first end associated with the lens for receiving the collected radiation and a second end. The focal point of the lens is at the first end of the fiber optic cable. The fiber optic cable transmits the received radiation from the first end to the second end. A detector is positioned at a remote distance from the railroad track and is associated with the second end of the fiber optic cable for detecting the transmitted radiation. The detected infrared radiation is indicative of the temperature of the wheel or bearing. The invention further comprises a method for detecting a temperature of the railroad train wheel or bearing, the apparatus comprising the steps of collecting in close proximity to a railroad track infrared radiation radiating from the wheel or bearing of a train traversing the track wherein the radiation is indicative of the temperature of the wheel or bearing. The invention further comprises the steps of transmitting the collected radiation to a location remote from the railroad track, detecting the transmitted radiation at the remote location, wherein the detected radiation is indicative of the temperature of the wheel or bearing, and generating an output signal that is indicative of the temperature of the wheel or bearing.

### BACKGROUND OF THE INVENTION

1. Field of the Invention

This invention relates generally to heat detectors for a railroad car wheel or bearing. More specifically, the present invention relates to the collection of heat associated with the wheel or bearing of railroad vehicles and the remote detection of the temperature of the wheel or bearing.

2. Brief Description of the Prior Art

In order to protect against railroad car wheel and bearing failures, most railroads utilize heat detectors along their rights of way and in close proximity to their railroad tracks. Such detectors view, through infrared scanners, the wheel or bearing of a passing train. If an overheated wheel or bearing is detected, an alarm is triggered to alert the train operator that an overheated wheel or bearing has been detected.

The infrared scanner and associated circuits for detecting overheated wheel or bearing are available commercially. Such systems utilize an infrared detector located in close proximity to a railroad track such that the detectors may detect the temperature of a wheel or bearing traversing the railway line. For example, a thermal detector such as used in the prior art is responsive to IR energy in the 1 to 30 micron wavelength spectrum. Such systems commonly use a lens or other optical apparatus to collect the radiated infrared waves from the wheel or bearing and focus the collected infrared radiation directly onto an infrared detection device. One such device is a pyroelectric cell equipped with a lithium tantalate crystal. The pyroelectric detector produces an output voltage that is proportional to the infrared temperature that passes through the detector's optics. The detector produces an alarm based on a predetermined threshold. For example, one such threshold in the prior art is where the voltage output from the pyroelectric cell or an associated preamplifier is greater than or equal to 3.25 volts. When such a threshold is exceeded, an alarm signal is generated.

In such systems, the detector and the associated other powered electronics are required to be in close proximity to the rail line and the rail vehicles traversing the rail line. As such, the electronics of the detectors are required to be placed in the adverse conditions that result from close proximity to rail lines and traversing rail vehicles. This environment is harsh due to the high G-forces, which is defined as mass times acceleration, associated with the heavy loads of rail vehicles, the higher levels of vibration caused by the traversing heavy loads and locomotive power systems, as well as the variations in the environment. High G-forces and vibrations cause negative piezoelectric affects that cause false high heat readings in pyroelectric cells that are located in close proximity to the rail line. Additionally, such forces also cause electronic circuitry in such environments to fail at a higher rate than those in non-high G-force environments.

In prior art systems, the detectors have been configured and designed to minimize the negative impact of the high G-forces. One such design is to align the pyroelectric detector or detector crystal on a vertical axis in an effort to reduce the microphonics effects of the high G-forces. In order to orient the detector or crystal in this manner, a high quality mirror is often required in order to focus the detection zone on the bearing or the wheel. The required orientation of the detector or crystal and the placement of the mirror have resulted in detectors that have strict design limitations that cause the detector to be larger (both taller and longer) than would be required to house the basic necessary detection components. Additionally, the arrangement of the detector or the crystal along with a high quality mirror adds undesirable costs and complexity to the detector implementations.

There is a need for an improved heat detector that can accurately respond to radiated infrared energy in the 1-14 micron wavelength region under adverse conditions of the rail system. It is desirable to have a detector that would not be responsive to conducted or convected thermal energy. It is also desirable to have a detector that does not exhibit negative piezoelectric effects that are caused by false high heat from the presence of high G-forces.

There is also a need for hot box and hot wheel detectors that are less expensive to manufacture, maintain, and operate There is also a need for a heat detection system with improved reliability, that reduces or eliminates false warnings and that produces consistent operating results over time. There is also a need for an improved system that can be used to retrofit existing railroad systems to improve their performance.

The present invention provides these improvements as well as other improvements over the prior art as will be in part described and in part implicit in the following descriptions.

### BRIEF DESCRIPTION OF THE INVENTION

The invention provides an improved apparatus and method for detecting the temperature of a wheel or bearing of railway vehicles traversing a railroad track.

One aspect of the invention comprises an apparatus for detecting a temperature of railroad train wheel or bearing. The apparatus comprises a lens positioned in close proximity to a railroad track such that infrared radiation radiating from the wheel or bearing of a train traversing the track is collected by the lens and directed toward a focal point of the lens. The collected radiation is indicative of the temperature of the wheel or bearing. The apparatus further comprises a fiber optic cable having a first end associated with the lens for receiving the collected radiation and having a second end. The fiber optic cable transmits the received radiation from the first end to the second end. The focal point of the lens is at the first end of the fiber optic cable. A detector is positioned at a remote distance from the railroad track and is associated with the second end of the fiber optic cable for detecting the transmitted radiation. The infrared radiation collected by the lens, transmitted by the fiber optic cable and detected by the detector is indicative of the temperature of the wheel or bearing.

Another aspect of the invention is an apparatus for detecting a temperature of a railroad train wheel or bearing. In this aspect, the apparatus comprises a lens positioned in close proximity to a railroad track such that infrared radiation radiating from the wheel or bearing of a train traversing the track is collected by the lens and directed towards a focal point of the lens. A fiber optic cable has a first end associated with the lens for receiving the collected radiation and a second end. The focal point of the lens is at the first end of the fiber optic cable. The fiber optic cable transmits the received radiation from the first end to the second end. A detector is positioned at a remote distance from the railroad track and is associated with the second end of the fiber optic cable for detecting the transmitted radiation. The infrared radiation collected by the lens is transmitted by the fiber optic cable and is detected by the detector. The infrared radiation is indicative of the temperature of the wheel or bearing. The detector generates an output signal that corresponds to the detected radiation. This aspect of the invention also comprises a circuit that compares the output signal to a reference to determine if the temperature exceeds a reference temperature.

In yet another aspect of the invention, the invention is an apparatus for detecting a temperature of a railroad train wheel or bearing comprising means for collecting infrared radiation radiating from the wheel or bearing of a train traversing the track wherein the radiation is indicative of the temperature of wheel or bearing. The collecting means is positioned in close proximity to a railroad track. This aspect of the invention further comprises means for transmitting the collected radiation from the collecting means to a location remote from the collecting means. A means for detecting the transmitted radiation has a location remote from the railroad track and from the collecting means. The detected radiation from the remote detector is indicative of the temperature of the wheel or bearing.

Another aspect of the invention is a method for detecting a temperature of a railroad train wheel or bearing. The method comprises collecting in close proximity to a railroad track infrared radiation radiating from the wheel or bearing of a train traversing the track. The radiation is indicative of the temperature of the wheel or bearing. A further step is transmitting the collected radiation to a location remote from the railroad track. Another step of this aspect of the invention is detecting the transmitted radiation at the remote location. The detected radiation is indicative of the temperature of the wheel or bearing. The next step is generating an output signal that is indicative of the temperature of the wheel or bearing.

Other aspects and forms of the invention will be in part apparent and in part pointed out hereinafter.

### BRIEF DESCRIPTION OF THE DRAWINGS

FIG. 1 is an illustration of a prior art railroad track with heat detectors.

FIG. 2 is an illustration of a prior art hot wheel detection system.

FIG. 3 is an illustration of a prior art pole-mounted hot wheel and/or hot bearing detection system.

FIG. 4 is an illustration of a prior art rail-mounted hot bearing detection system.

FIG. 5 is an illustration of a hot wheel remote detection system corresponding to one embodiment of the invention.

FIG. 6 is an illustration of a heat collector assembly corresponding to one embodiment of the invention.

FIG. 7 is an illustration of the components of a remote heat detector corresponding to one embodiment of the invention.

FIG. 8 is an illustration of a pole-mounted remote hot wheel and/or hot bearing detection system corresponding to one embodiment of the invention.

FIG. 9 is an illustration of a rail-mounted remote heat detection system corresponding to one embodiment of the invention.

Corresponding reference characters indicate corresponding parts throughout the drawings.

### DETAILED DESCRIPTION

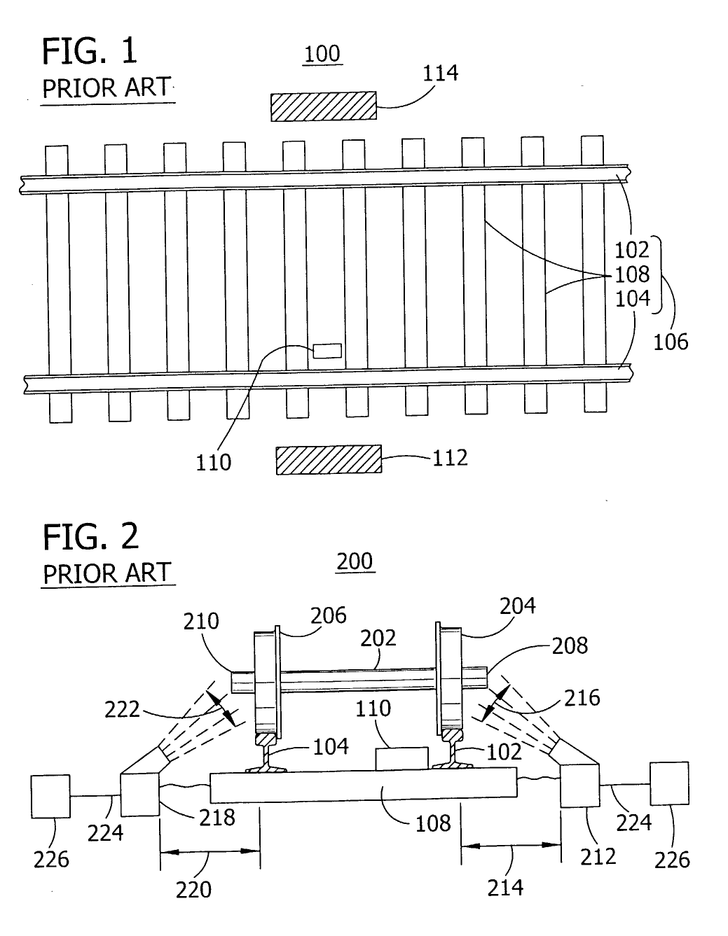

Referring to FIG. 1, a railroad track 106 comprises a first rail 102, a second rail 104 and a plurality of cross ties 108. In a standard heat detection system, a railway vehicle or train detector 110 is located between the first rail 102 and the second rail 104 to detect the presence of a railway vehicle as it passes over the train detector 110. A first heat detector 114 is located in close proximity to the first rail 102. A second heat detector 112 is located in close proximity to the second rail 104. In prior art systems the first heat detector 114 is located opposite of the second heat detector 112. Additionally, the first heat detector 114 and the second heat detector 112 are located in close proximity and in axial alignment with the train detector 110 as illustrated in FIG. 1.

Referring to FIG. 2, one prior art form of a railroad heat detection system is a hot wheel detection system. A train is equipped with a plurality of axles 202 having a first wheel 204 that traverses the first rail 102 and a second wheel 206 traverses the second rail 104. First wheel 204 is configured with a first bearing 208 and the second wheel 206 is configured with a second bearing 210. A first hot wheel detector 212 is located a distance 214 from the first rail 102. A second hot wheel detector 218 is located a distance 220 from the second rail 104. Traditionally, first distance 214 and the second distance 220 are short distances such that the respective detectors are in close proximity to the rails and to the wheel or bearing traversing the rails. This is required since the heat detection zone 216 of the first detector 212 and the heat detection zone 222 of the second detector 218 require a relatively close position to the rail 102 and the wheel 204 traversing the rail in order to adequately determine the temperature of the wheel. The first heat detector 212 and the second heat detector 218 detect the heat emitted by the traversing wheels 204 and 206 when the train detector 108 senses or detects the presence of an axle 202 or wheels 204 and 206 or railway vehicle (not shown) immediately above the train detection sensor 110. The heat detectors 212 and 218 detect the heat of the traversing wheel 204 or 206 and generate an output signal either indicating the presence of a wheel that exceeds a preset temperature or an output signal that indicates the temperature of wheel 204 or 206. The heat detectors 212 and 218 are interconnected with a hot wheel detection system 226, which is remote from the hot wheel detectors 212 and 218 but which is interconnected by a communication facility 224 for transmitting an output signal. The communication facility 224 communicates an alarm signal or a signal indicative of the temperature of the detected hot wheel or bearing to a remote monitoring or administrative system such as a hot box, hot bearing or hot wheel detection system 226.

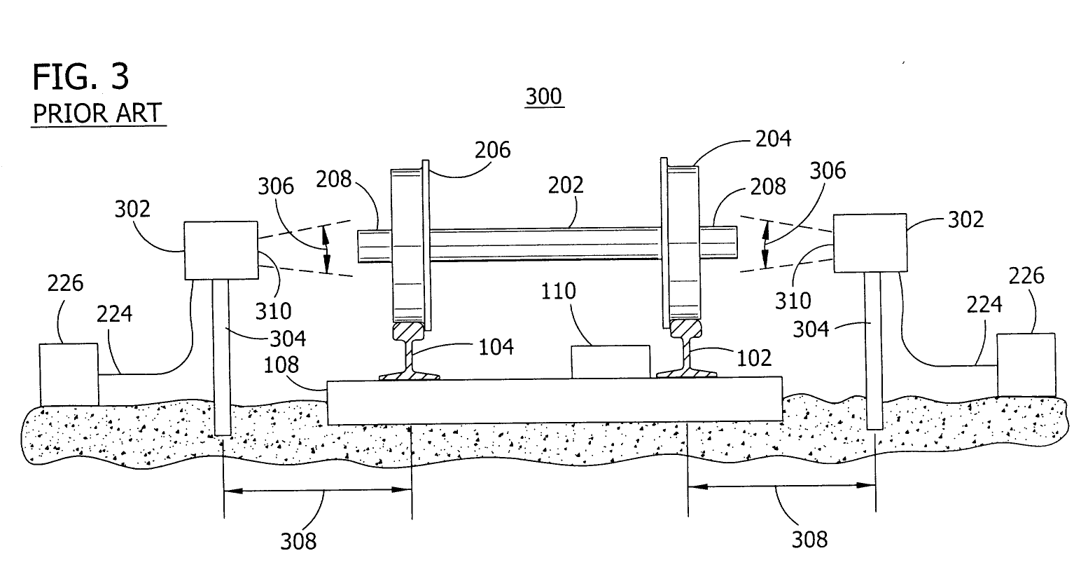

As shown is FIG. 3, a similar arrangement detects a hot wheel 204 or a hot bearing 208 (herein after referred to as simply a hot bearing) associated with the wheel 204 and bearing 208 traversing a railroad track 106. In this case, a hot wheel or hot bearing detector 302 (herein after referred to as the hot bearing detector 302) is mounted on a pole 304 such that a narrower sensing zone 306 senses the temperature of the wheel 204 or bearing 208 of the traversing railway vehicle. The hot bearing detector 302 is mounted on a pole 304 in close proximity to the railroad rails 102 and 104 as denoted by distance 308. In some cases, hot bearing detector 302 is mounted on the pole 304 such that hot bearing sensor window 310 is axially aligned with the axle 202 and therefore the bearing 208. This is desirable for hot bearing detector 302 to have a relatively small zone of detection 306 focused on the traversing bearing 208. In this pole-mounted hot wheel or hot bearing detection arrangement 300, the hot bearing detector 302 detects the heat of the traversing wheel 204 or bearing 208 and communicates an alarm or a detected temperature signal to a remote hot bearing detection system 226 via a communication link 224.

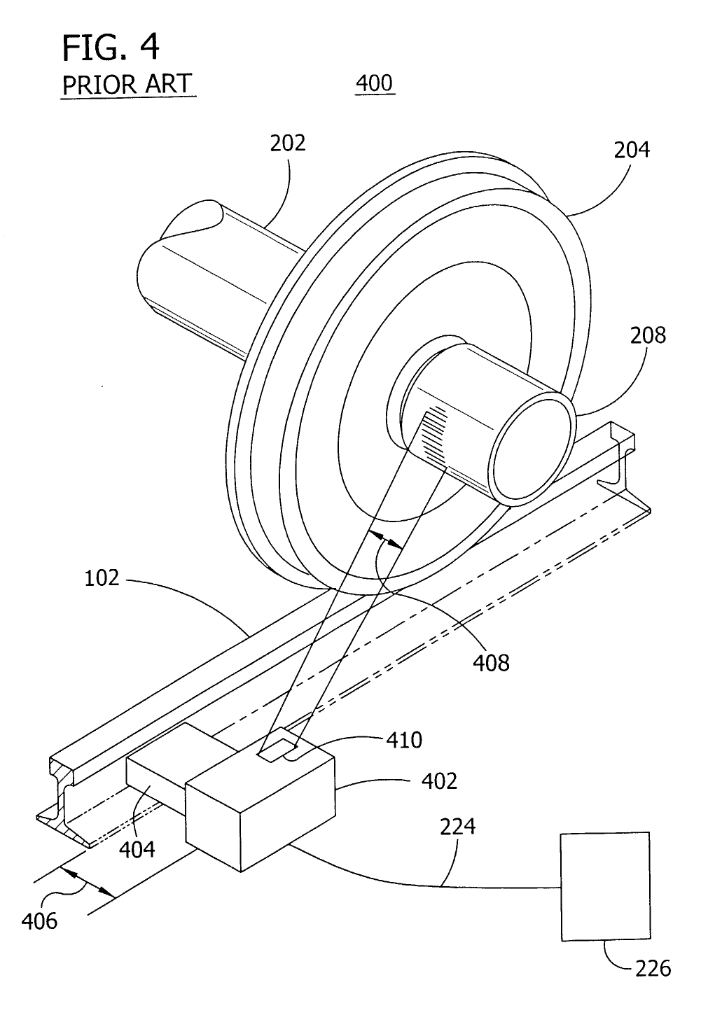

As shown if FIG. 4, a hot bearing is also detected at vertical direction by a hot bearing detector that is mounted on a rail directly beneath a traversing railway vehicle. A rail-mounted hot bearing detector 402 is mounted by a mounting apparatus 404 to rail 102. FIG. 4 shows one embodiment of such a mounting apparatus. However, other mounting arrangements are contemplated by the invention but are not shown. The rail-mounted hot bearing detector 402 is positioned at a close distance 406 from rail 102 such that the sensor window 410 for hot bearing detector 402 has a sensor zone 408 which detects the temperature of bearing 208. Generally, this distance 406 is very small such as in the range of 1 to 30 centimeters. As such, the rail-mounted detector 402 is in close proximity to both the rail 102 and the rail vehicle. Rail-mounted detector 402 generates an output signal on communication link 224 that is communicated to a remote hot bearing detection system 226. The output signal of the detector 402 may be an alarm where the temperature of the detected bearing exceeds a pre-defined temperature or may be the detected temperature of the detected bearing 208.

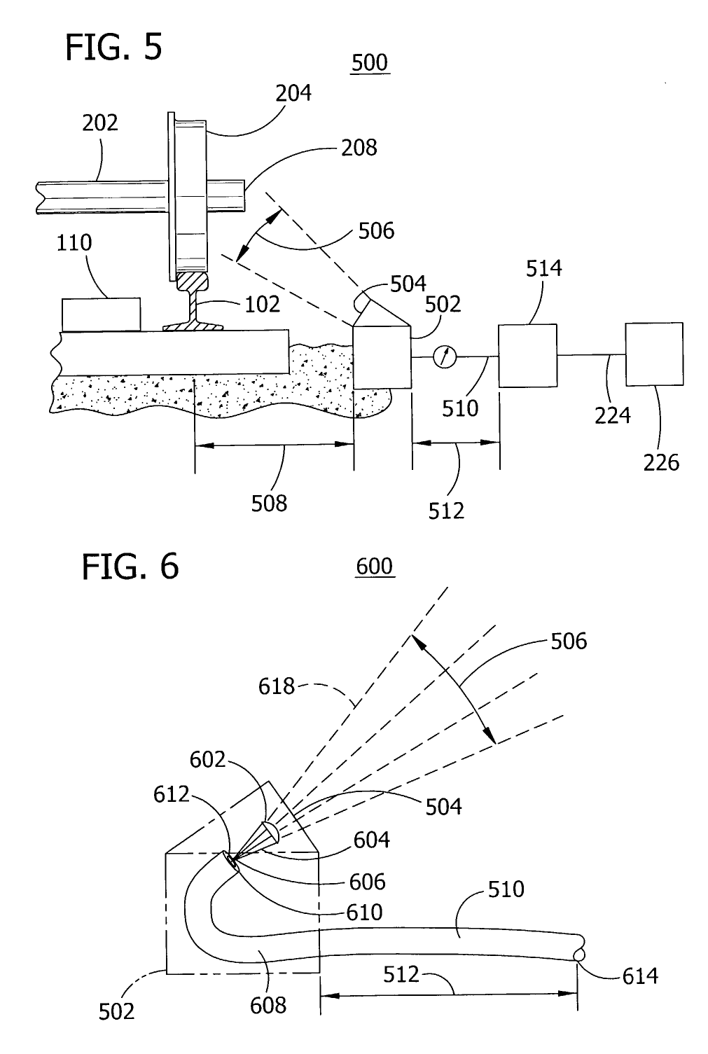

Referring now to FIG. 5, the present invention comprises a remote hot wheel detection system 500. As discussed before, wheel 204 is connected to axle 202 by bearing 208. The wheel 204, axle 202 and bearing 208 assembly traverses rail 102. A hot wheel heat collector 502 is located a distance 508 from rail 102 and wheel 204. Distance 508 may be between a few centimeters to 1 to 3 meters. Hot wheel heat collector 502 has a heat collector window 504 that detects heat in heat detection zone 506. Heat collector 502 is connected to a remote heat detector 514 by a fiber optic cable 510. Remote heat detector 514 is located a distance 512 from heat collector 502. Remote heat detector 514 has a communications link 224 which communicatively connects the remote heat detector 514 to a remote hot wheel or hot bearing detection system 226. In one embodiment of the present invention, heat collector 502 is in close proximity to the wheel 204, bearing 208 and rail 102. As one example, this distance 508 would be one meter. However, the heat detector 514 that contains the electronics that determines the detected temperature of the hot wheel 204 or bearing 208 is located at a remote distance 512 from the rail 102, the wheel 204 and the bearing 208. In one embodiment, the distance may be 2 to 10 meters. This remote distance 512 may vary based on geography, implementation requirements or other external factors. The remote distance 512 should be such as to remotely locate the electronics of the heat detector 514 from close proximity to the rail 102 and the traversing railway vehicle, thereby minimizing the negative effects of the G-forces of a traversing railway vehicle on the detector 514 and its electronics.

As shown in FIG. 6, one embodiment of a heat collector 502 and fiber optic cable 510 is shown as assembly 600. This heat collector assembly 600 has a heat collector window 504 that transmits infrared radiation 618 generated by the wheel 204 or bearing 208. The radiation 618 is indicative of the temperature of the wheel 204 or bearing 208 of a traversing railway vehicle. A lens 602 has a focal point 606. Lens 602 collects the radiation 618 within the zone of detection 506 and focuses the collected radiation 606 to focal point 610. A zone of detection 612 of the detected radiation 618 may vary depending on such factors as the distance of the collector 502 from the track, the design of assembly 600 and the sensitivity of the system 500. The collector 502 further comprises a fiber optic cable 510, a portion of which is located within the collector assembly 502 as denoted by 608. Fiber optic cable 510 has a first end 610 that is located within the collector assembly 502. The fiber optic cable 510 further has a core 612 that is the portion of the fiber optic cable 510 configured to transmit infrared radiation. The fiber optic cable 510 has a second end 614 that is located at a distance 512 from the collector 502. A fiber optic cable 510 is configured to transmit radiation indicative of the collected radiation 606 as collected by lens 602. In one such embodiment, where the collected heat is infrared radiation with wavelengths of one micron to 30 microns and corresponding frequencies of 3.0×10¹⁴ and 1.0×10¹³, respectively, the fiber optic cable 510 may be configured to transmit infrared radiation having a wavelength of 8 to 14 microns, or a frequency of 3.0×10¹⁴ and 2.14×10¹³. The first end 610 of the fiber cable 610 is positioned relative to the focal point 606 of lens 602 such that collected radiation 604 is transferred or communicated to the transmission portion of the fiber optic cable 510 which may be the core 612. An optically connected arrangement between the lens 602 and the first end 610 of the fiber optic cable 510 may vary as necessary for the collected radiation 606 to be transferred by fiber optic cable 510 from the first end 610 to the second end 614. While not shown in FIG. 6, various other methods of optically interconnecting the lens 602 with the fiber optic cable 610 is contemplated by the present invention. For example, the first end 610 of the fiber optic cable 510 may not be positioned to directly receive the collected radiation 610 of lens 602. This optical coupling may be performed indirectly or may include an optical wave-guide such that the collected radiation is transferred to the fiber optic cable 510 for transmission from the first end 610 to the second end 614.

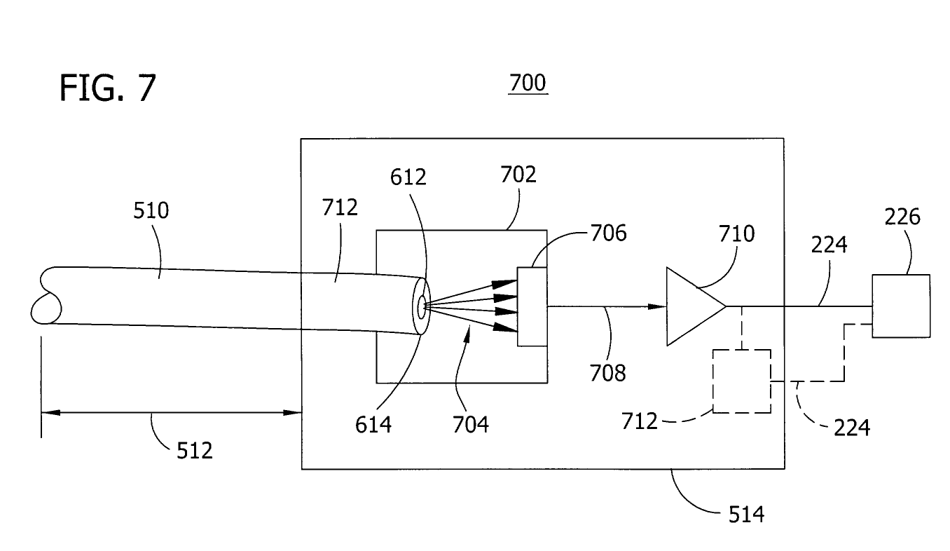

FIG. 7 illustrates a heat detector assembly 700 according to one embodiment of the invention. The second end 614 of fiber optic cable 510 engages heat detector 514. A portion of fiber cable 510 may be located internal to the heat detector 514 as indicated by 712. As shown in FIG. 7, a heat-detecting device 702 is located in the heat detector assembly 700. One such heat-detecting device 702 know in the art is a pyroelectric cell. However, other such heat detecting devices 702 may also be applicable and applied to other embodiments of the invention. The second end 614 of fiber optic cable 510 is positioned within the heat detector assembly 700 and associated with the heat-detecting device 702 such that the collected and transmitted radiation 704 is transmitted from the second end 614 of the fiber cable 510 and received by the heat detection device 702. The fiber-emitted infrared radiation 704 is received by a heat-detecting element 706 that is a part of the heat-detecting device 702. Heat-detection elements 706 are known in the art and may comprise an infrared array, a lithium tantalate crystal or similar device capable of detecting the temperature as indicated by the infrared radiation 704.

The heat-detecting element 706 provides an output signal 708 that is indicative of the heat of the transmitted infrared radiation 704 that corresponds to the collected radiation 604 and therefore is indicative of the temperature of the traversing wheel 204 or bearing 208. The output signal 708 of the heat-detecting element 706 is input into an amplifier 710. Of course, the amplifier 710 may also be a pre-amplifier circuit. The output signal 708 of the detector 700 is a signal that is indicative of the temperature of the wheels 204 and 206 or bearings 208 and 210. The output signal 708 of the amplifier 710 is transmitted, in one embodiment, to a remote heat detection system 226 by communication link or facility 224. The distance of communication facility 224 may range from a few meters to several hundred kilometers. While FIG. 7 illustrates one embodiment, the invention may include other heat detector 514 assemblies or configurations.

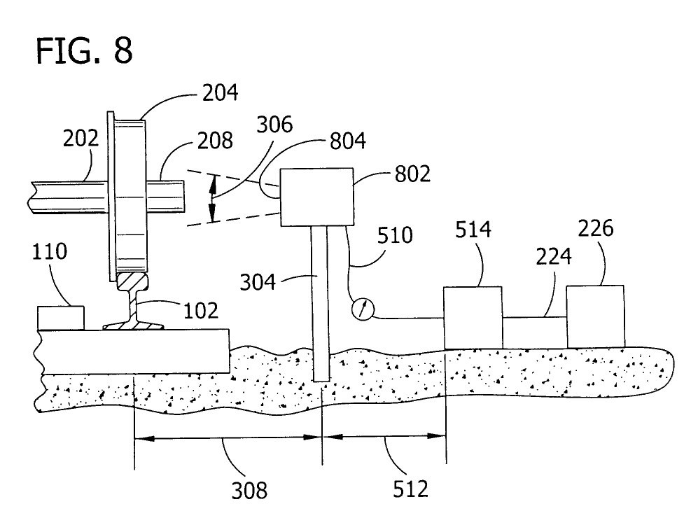

In another embodiment as illustrated in FIG. 8, a heat collector 802 is arranged in relation to a rail 102, wheel 204 or bearing 208 such as to be able to detect the temperature of the traversing bearing 208. A heat collector 802 is mounted on a pole 304 such that heat detector 802 and heat detector window 804 creates a detection zone 306 that detects the temperature of bearing 208. In this case, heat collector 802 collects the radiated radiation that indicates the temperature and transmits the collected infrared signals 606 from the collector 802 to the remote detector 514. The remote detector 514 is placed at a distance 512 from the collector 802 as is necessary to remove the detector 514 and its electronic components from close proximity to the rail 102 and the traversing railway vehicle.

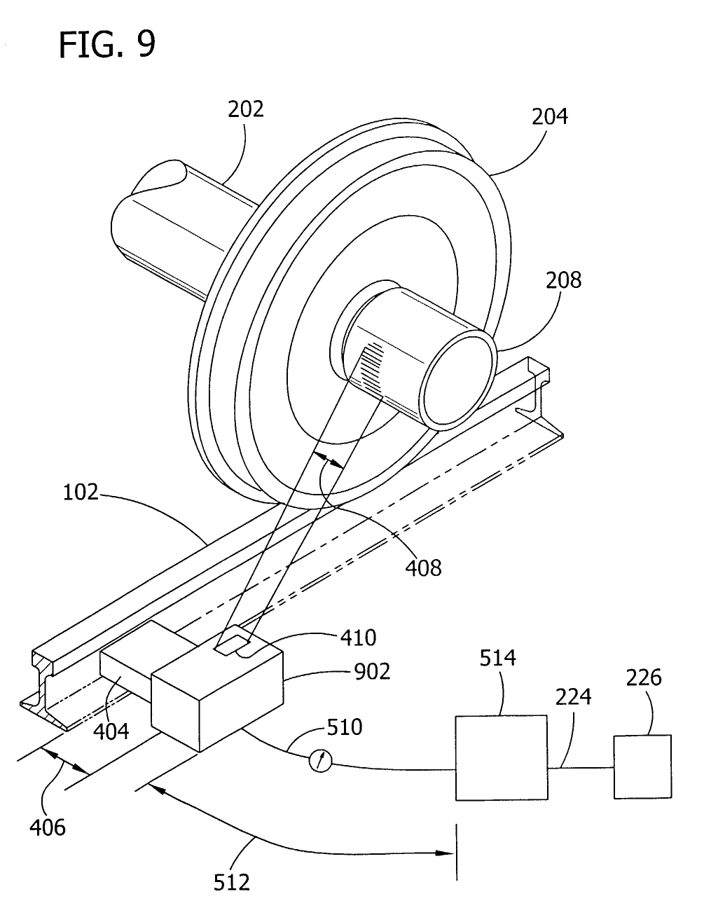

In yet another embodiment, as shown in FIG. 9, a heat collector 902 is mounted to a rail 102 by a mounting assembly 404 such that the collector window 410 is beneath the traversing bearing 208 of a railway vehicle. Of course, the heat collector 902 may also be mounted to a crosstie 108 rather than a rail. The distance 406 of the heat collector 902 from the rail 102 is such that a collector window 410 creates a detection or sensor zone 408 that collects radiation that is indicative of the temperature of the bearing 208. A fiber optic cable 510 connects the heat collector 902 to a remote heat detector 514. Heat collector 902 transmits the collected radiation 606 from the heat collector 902 to the remote heat detector 514 via this fiber optic cable 510. As discussed above, the remote heat detector 514 is located at a distance 512 from the rail 102 and the traversing railway vehicle. Remote heat detector 514 communicates a signal to the remote heat detection system 226 via a communication facility or link 224.

From the above description, it can be seen that by separating the collection of the radiation 506 which is indicative of the temperature of the wheel 204 or bearing 208 from the detection electronics, the present invention provides an improved system and method for detecting the temperature of a wheel 204 or bearing 208 of a railway vehicle traversing a rail 102. The collection of the emitted radiation by a heat collector 502 is passive thereby eliminating the need for active or powered electronic circuitry in close proximity to the rail 102 or the traversing train. Collector 502 collects the radiation 506 and transmits the radiation via the fiber optic cable 510 to a remote detector 514. The remote detector 514, being located a distance 512 away from the collector 502 and therefore the rail 102 and the traversing railway vehicle, is located in a safer environment not affected by the harsh environment associated with close proximity to a rail line such as high G-forces, which are defined as mass times acceleration. High G-forces associated with the traversing of very heavy and fast moving trains causes micro phonics that negatively impact microelectronics circuits such as are necessary for temperature detection. Such negative effects may be the creation of false voltage outputs from electronic devices or may include physical damage to the electronics components.

It is also contemplated that the system and method of the invention may be implemented as a retrofit kit to an existing hot wheel or hot bearing detection system. For example, as discussed in the prior art, existing hot wheel or hot bearing detectors are located in close proximity to the rail 102. In other embodiments of the invention, the components of the prior art system may be removed from their detection assemblies and replaced with the heat collector assembly components as shown in FIG. 6. In such a case, the fiber optic cable 510 is installed such that a new heat detector assembly 514 is located distance 512 from the collector 502.

Of course, the arrangement as illustrated in FIG. 6 is illustrative of only one embodiment of a heat collector assembly 600. The embodiment illustrated in FIG. 6 is adapted to the prior art system of hot wheel detection as described above with regards to FIG. 2. In other embodiments the components and arrangements as illustrated in FIG. 6 may be applied to other heat detector arrangements known in the art. For example, as described above, a heat collector assembly 600 is configured as a pole-mounted bearing heat collector 802 as shown in FIG. 8. In yet another embodiment, a heat collector 600 is embodied as a rail-mounted bearing collector 902 as illustrated in FIG. 9.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

While various embodiments of the present invention have been illustrated and described, it will be appreciated to those skilled in the art that many changes and modifications may be made thereunto without departing from the spirit and scope of the invention. As various changes could be made in the above constructions without departing from the scope of the invention, it is intended that all matter contained in the above description or shown in the accompanying drawings shall be interpreted as illustrative and not in a limiting sense.

1. An apparatus for detecting a temperature of a railroad train wheel or bearing, the apparatus comprising:
a lens positioned in close proximity to a railroad track such that infrared radiation radiating from the wheel or bearing of a train traversing the track is collected by the lens and directed toward a focal point of the lens, wherein the collected radiation is indicative of the temperature of the wheel or bearing;
a fiber optic cable having a first end associated with the lens for receiving the collected radiation and having a second end, the fiber optic cable transmitting the received radiation from the first end to the second end, and wherein the focal point of the lens at the first end of the fiber optic cable; and
a detector positioned at a remote distance from the railroad track, the detector associated with the second end of the fiber optic cable for detecting the transmitted radiation, wherein the infrared radiation collected by the lens, transmitted by the fiber optic cable and detected by the detector is indicative of the temperature of the wheel or bearing.

2. The apparatus of claim 1, wherein the detector is a pyroelectric cell.

3. The apparatus of claim 2, wherein the pyroelectric cell includes a lithium tantalate crystal.

4. The apparatus of claim 2, further comprising a preamplifier that amplifies the output of the pyroelectric cell and produces an output signal that is indicative of the temperature of the wheel or bearing.

5. The apparatus of claim 4, further comprising a hot wheel and/or hot bearing detection system receiving the output signal.

6. The apparatus of claim 1, wherein the fiber optic cable is configured to transmit infrared radiation having a wavelength in the range of 8 to 14 microns.

7. The apparatus of claim 1, wherein the detector generates an output signal that is indicative of the detected radiation.

8. The apparatus of claim 7, further comprising a circuit comparing the output signal to a reference and generating an alarm when the difference between the output signal and the reference is greater than a predetermined amount.

9. The apparatus of claim 8, wherein the circuit comprises a hot wheel and/or hot bearing detection system.

10. An apparatus for detecting a temperature of a railroad train wheel or bearing, the apparatus comprising:
a lens positioned in close proximity to a railroad track such that infrared radiation radiating from the wheel or bearing of a train traversing the track is collected by the lens and directed towards a focal point of the lens, wherein the collected radiation is indicative of the temperature of the wheel or bearing;
a fiber optic cable having a first end associated with the lens for receiving the collected radiation and having a second end, the fiber optic cable transmitting the received radiation from the first end to the second end;
a detector positioned at a remote distance from the railroad track, the detector associated with the second end of the fiber optic cable for detecting the transmitted radiation and wherein the infrared radiation collected by the lens, transmitted by the fiber optic cable and detected by the detector is indicative of the temperature of the wheel or bearing, and wherein the detector generates an output signal that is indicative of the detected radiation; and
a circuit comparing the output signal to a reference to determine if the temperature exceeds a reference temperature.

11. The apparatus of claim 10, wherein the detector is a pyroelectric cell.

12. The apparatus of claim 11, further comprising:
a preamplifier that amplifies the output of the pyroelectric cell and produces an output signal that is indicative of the temperature of the wheel or bearing; and
a hot wheel and/or hot bearing detection system receiving the output signal.

13. An apparatus for detecting a temperature of a railroad train wheel or bearing, the apparatus comprising:
means for collecting infrared radiation radiating from the wheel or bearing of a train traversing the track wherein the radiation is indicative of the temperature of the wheel or bearing and wherein the collecting means is positioned in close proximity to a railroad track;
means for transmitting the collected radiation from the collecting means to a location remote from the collecting means; and
means for detecting the transmitted radiation, wherein the detecting means has a location remote from the railroad track and from the collecting means, and wherein the detected radiation is indicative of the temperature of the wheel or bearing.

14. The apparatus of claim 13, wherein the collecting means is a lens with a focal point, wherein the lens collects the infrared radiation and the focal point of the lens is focused on the transmitting means.

15. The apparatus of claim 13, wherein the detecting means is a pyroelectric cell that includes a lithium tantalate crystal.

16. The apparatus of claim 13, wherein the detecting means comprises a preamplifier that amplifies an output of the pyroelectric cell, further comprising a generating means for generating a signal that is indicative of the temperature of the wheel or bearing.

17. The apparatus of claim 16, further comprising a processing means for comparing the output of the generating means to a reference and for generating an alarm as a function of the difference between the output of the generating means and the reference, wherein the detecting means generates an output signal that is indicative of the detected radiation.

18. A method for detecting a temperature of a railroad train wheel or bearing, the apparatus comprising:
collecting in close proximity to a railroad track infrared radiation radiating from the wheel or bearing of a train traversing the track wherein the radiation is indicative of the temperature of the wheel or bearing;
transmitting the collected radiation to a location remote from the railroad track;
detecting the transmitted radiation at the remote location, wherein the detected radiation is indicative of the temperature of the wheel or bearing; and
generating an output signal that is indicative of the temperature of the wheel or bearing.

19. The method of claim 18, further comprising:
comparing the output signal to a reference to determine if the temperature exceeds a reference temperature.
